(19) United States
(12) Patent Application Publication
(10) Pub. No.: US 2003/0097270 A1
(43) Pub. Date: May 22, 2003

(54) Methods, systems and articles of manufacture for providing financial accounts with incentives

(76) Inventors: Eric Lee Musselwhite, Richmond, VA (US); Daniel Guy Baker, Glen Allen, VA (US); Krishnamurthy Bindumadhavan, Richmond, VA (US); Deborah Amie Candeub, Arlington, VA (US); Lisa Michele Chancellor, Mechanicsville, VA (US); Sanjeev Kumar Chandak, Richmond, VA (US); Brad Jiulianti, Boise, ID (US); William Joseph McSorley IV, Springfield, VA (US)

Correspondence Address: Finnegan, Henderson, Farabow,, Garrett & Dunner, L.L.P., 1300 I Street, N.W., Washington, DC, 20005-3315, US

(21) Appl. No.: 09/987,952

(22) Filed: Nov. 16, 2001

(51) Int. Cl. G06F 17/60

(52) U.S. Cl. 705/1; 705/40

(57) ABSTRACT

Methods, systems, and articles of manufacture for providing advantage credit card products to customers is disclosed. A financial account provider may provide a consumer with a financial account that may be used for purchase transactions with vendors. Additionally, the financial account provider may allow the consumer to select a vendor to be associated with the financial account. Thereafter, the financial account provider may charge fees to the financial account for purchase transactions with the selected vendor based on advantage account parameters. Furthermore, fees may be charged to the financial account by the financial account provider for purchase transactions with other vendors based on standard account parameters. The one or more advantage account parameters may include terms that are more favorable to the consumer than terms associated with standard account parameters. For instance, the advantage account parameters may include an interest rate that is lower than an interest rate included with the standard account parameters.

### BACKGROUND OF THE INVENTION

I. Field of the Invention

This invention relates to credit card products and, more particularly, to systems, methods, and articles of manufacture for providing a line of credit with incentives associated with a customer selected vendor.

II. Background and Material Information

Credit card products have become so universally well known and ubiquitous that they have fundamentally changed the manner in which financial transactions and dealings are viewed and conducted in society today. Credit card products are most commonly represented by plastic card-like members that are offered and provided to customers through credit card issuers (such as banks and other financial institutions). With a credit card, an authorized customer or cardholder is capable of purchasing services and/or merchandise without an immediate, direct exchange of cash. With each purchase, the cardholder incurs debt to their credit card account, which the cardholder may thereafter pay upon receipt of a monthly or otherwise periodic statement. In most cases, the cardholder will have the option to either fully pay the outstanding balance or, as a matter of necessity or choice, defer at least a portion or the balance for later payment with accompanying interest or finance charges for the period during which payment of the outstanding debt is deferred (also referred to as a revolving charge credit line).

The spending power of a credit card (i.e., the maximum amount of funds that is financed to the cardholder for making purchases) is typically limited to a particular amount that is predetermined by the issuer of the card. This amount is commonly referred to as the “credit limit” of the credit card. The credit limit provides the cardholder with a line of credit (also referred to as a credit line). The size of the issuer-imposed credit limit is generally based on a number of non-exclusive factors, the most important of which are often the cardholder's earning capacity and the cardholder's credit history. When purchases are made or debts incurred with the credit card, the available portion of the credit limit is reduced by the purchase or debt amounts. In addition, interest and/or finance charges are also subtracted from the available portion of the credit limit on a periodic basis. The total debits on a credit card are referred to as the “outstanding balance,” while the remaining or available balance of the credit limit is typically called the “available balance” and reflects the dynamically adjusted current spending power of the credit card. The cardholder may increase the available balance up to the credit limit, by paying the outstanding balance to the issuer.

Credit card issuers usually provide general purpose credit cards that may be used for a plurality of different goods and services and with a wide variety of merchants. For example, Visa, MasterCard, and American Express are examples of general purpose credit cards. Since general purpose credit cards are intended for “general use” by a cardholder, they are typically not associated with a single merchant/vendor or limited in use.

Some merchants issue private label credit cards (e.g., a Sears Charge Card) for use exclusively with that merchant's goods and/or services. Such private label credit cards may be issued to customers of the merchant to provide an incentive to purchase the goods and/or services of the merchant. Private label credit cards may be issued with different types of terms and conditions. For example, a private label credit card may include a private label credit line with a predetermined credit limit and the possibility of deferring payment on an outstanding balance with a finance or interest charge (e.g., a revolving credit line). A private label credit card may also include a charge account that requires the cardholder to pay the balance in full at the end of each month or the card may include an installment line of credit where the cardholder is required to make a fixed, periodic payment to the merchant (or the merchant's representative) until the installment debt is paid.

Private label credit cards have several disadvantages. For example, the credit line of a private label credit card may only be used to make purchases in connection with the merchant's goods and/or services. As a result, a private label credit card limits a customer's overall use of the credit card. Moreover, if the private label credit card includes a charge account that requires full payment of the outstanding balance at the end of the month, the cardholder tends to limit use of the merchant's credit card to an amount that can be paid at the end of the month.

To overcome the above mentioned disadvantages, credit cards have been created that offer dual lines of credit. Dual line credit cards include a general purpose credit line and a private label credit line. Dual line cards provide cardholders with the ability to purchase goods from a specific merchant or make general purchases for a wide variety of goods or services. Although dual line credit cards provide advantages over conventional credit cards, the private label credit line is limited to merchants selected by the credit card issuer. Generally, a merchant is selected based on a partnership agreement between the credit card issuer and the merchant associated with the private label credit line. Thus, customers are restricted in using their private label credit lines at merchant sites selected by the credit card issuer.

### SUMMARY OF THE INVENTION

It is therefore desirable to associate a credit card account with a vendor selected by the card holder such that the card holder may benefit from more favorable account terms for purchases from the selected vendor, while still allowing the account to be used as a general purpose credit line for purchases from other vendors.

Methods, systems, and articles of manufacture consistent with the principles of the present invention enable a financial account provider to offer a customer a financial account, such as a credit card account, associated with a vendor that may be selected by the customer. The financial account may be associated with a first account parameter that is applied to purchase transactions made with the selected vendor. Furthermore, the financial account may be associated with a second account parameter that is applied to purchase transactions made with other vendors. In one configuration consistent with certain principles related to the present invention, the first and second account parameters may be different finance fees, such as interest rates, that are applied to the respective purchase transactions.

It is to be understood that both the foregoing general description and the following detailed description are exemplary and explanatory only and are not restrictive of the invention, as described. Further features and/or variations may be provided in addition to those set forth herein. For example, the present invention may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of this specification, illustrate various embodiments and aspects of the present invention and, together with the description, explain the principles of the invention. In the drawings:

FIG. 1 illustrates an exemplary system environment in which certain features and principles related to the present invention may be implemented;

FIG. 2 is a flowchart of an exemplary process for offering advantage credit card products to target customers, in accordance with certain principles related to the present invention;

FIG. 3 is a flowchart of an exemplary process for processing vendor selections from customers, in accordance with certain principles related to the present invention;

FIG. 4 is an exemplary system environment for processing transactions associated with an advantage credit card product, in accordance with certain principles related to the present invention;

FIG. 5 is a flowchart of an exemplary process for processing a purchase transaction, in accordance with certain principles related to the present invention;

FIG. 6 is a flowchart of another exemplary process for processing a purchase transaction, in accordance with certain principles related to the present invention; and

FIG. 7 is a flowchart of an exemplary process for providing billing statements, in accordance with certain principles related to the present invention.

### DETAILED DESCRIPTION

Reference will now be made in detail to the invention, examples of which are illustrated in the accompanying drawings. Wherever possible, the same reference numbers will be used throughout the drawings to refer to the same or like parts.

Generally, the present invention is directed to methods, systems, and articles of manufacture for providing a financial account that is associated with a particular vendor selected by the card holder. In accordance with one configuration consistent with certain principles related to the present invention, target customers may be initially presented with offers for obtaining an advantage credit card product. These offers may be presented through any type of solicitation technique, such as conventional mail or web page advertisements. The advantage credit card product may include a general purpose line of credit associated with “standard credit parameters” including “standard credit terms,” such as a determined credit limit and a standard interest rate. The advantage credit card product may also be associated with one or more “advantage credit parameters” that may include “advantage credit terms” that vary from the standard credit terms, such that they are more favorable to the customer. For example, an advantage credit parameter may include an interest rate that is lower than an interest rate included in the standard credit parameter. The advantage credit parameter may then be applied to purchase transactions related to a vendor that is selected by the card holder prior to obtaining the advantage credit card product. While features of the present invention may be described herein in the context of the financial account being a credit card account, the present invention may be used for other types of financial accounts, such as debit cards and check cards.

In one configuration consistent with certain principles related to the present invention, a credit card issuer may process a customer's billing statement based on purchases of goods and/or service from a selected vendor. For example, a customer's advantage credit line may have a single credit limit that is adjusted based on transactions associated with both the selected vendor and other non-selected vendors. Finance charges, however, may be processed separately for each of the two sets of transactions based on the standard and advantage credit parameters. In one configuration consistent with certain principles related to the present invention, the selected vendor transactions may be processed based on an advantage interest rate, while the non-selected vendor transactions may be processed based on a standard interest rate, which may be higher than the advantage interest rate.

The above-noted features and other aspects and principles of the present invention may be implemented in various environments. Such environments and related applications may be specially constructed for performing the various processes and operations of the invention or they may include a general purpose computer or computing platform selectively activated or reconfigured by program code to provide the necessary functionality. The processes disclosed herein are not inherently related to any particular computer or other apparatus, and may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

The present invention also relates to computer readable media that include program instruction or program code for performing various computer-implemented operations based on the methods and processes of the invention. The program instructions may be those specially designed and constructed for the purposes of the invention, or they may be of the kind well-known and available to those having skill in the computer software arts. Examples of program instructions include for example machine code, such as produced by a compiler, and files containing a high level code that can be executed by the computer using an interpreter.

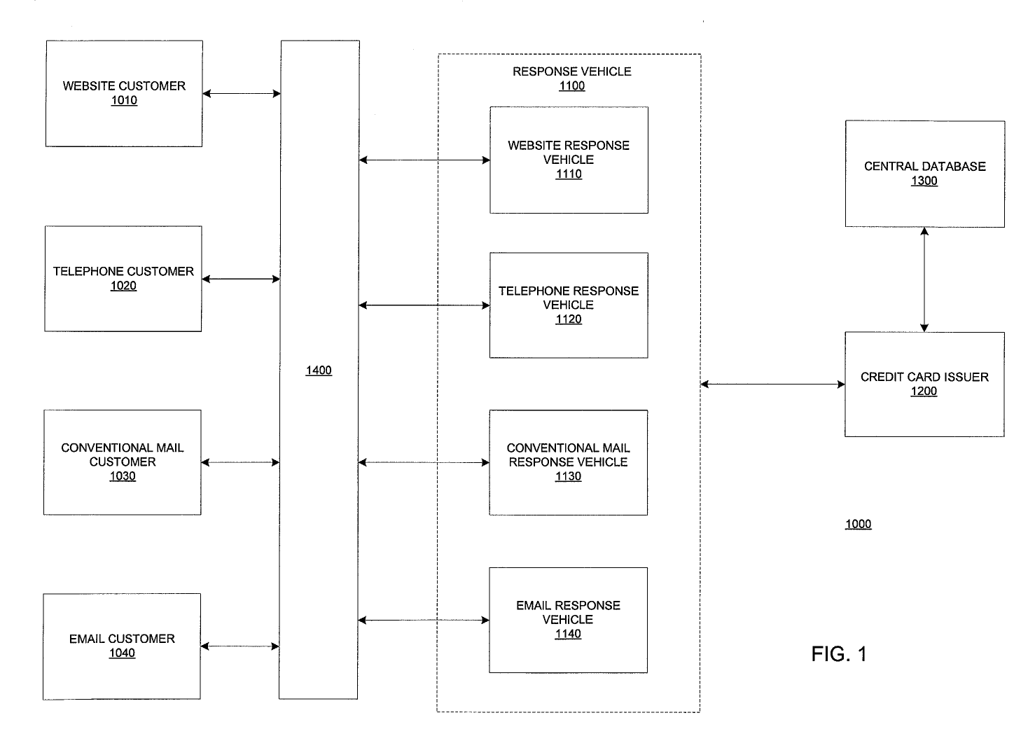

FIG. 1 illustrates an exemplary system environment 1000 in which the features and principles of the invention may be implemented. As illustrated in FIG. 1, the system environment 1000 includes a plurality of customers (1010-1040), a response vehicle system 1100 including a plurality of different response vehicles (1110-1140), a credit card issuer 1200, a central database 1300, and a communications channel 1400.

Each customer in system environment 1000 is associated with a different customer category. For instance, customers 1010 may be web site customers that access and retrieve information through a web site. This web site may be a branded web site that is operated by one or more vendors, or may be a web site operated by the card issuer. Customers 1020 may be telephone customers that access and receive information using conventional telephonic communication techniques and systems. This includes, for example, wireline and wireless telephony systems. Customers 1030 may be conventional mail customers that access and receive information by conventional mail techniques and services. This includes, for example, customers that are part of a credit card issuer's mailing list. Finally, customers 1040 may be customers that access and receive information using electronic mail services. Customers 10101040 may also represent entities (such as an individual, a group of individuals, corporate entities, or any combination thereof), that hold credit card accounts with the credit card issuer 1200. The categories of customers illustrated in FIG. 1 are exemplary and should not be considered limiting. For example, a variety of different customer categories may also be implemented in environment 1000, such as customers using kiosk computers or personal digital assistants (PDAs).

Response vehicle 1100 represents a system for handling communications between the customers 1010-1040 and credit card issuer 1200. Response vehicle 1100 may be part of a credit card issuer's network and, as shown in FIG. 1, include a plurality of response vehicles 1110-1140 that correspond to different category groups of customers 1010-1040. Each response vehicle is responsible for handling communications to and from a particular customer. For example, website response vehicle 1110 may handle Internet related communications, such as web based transactions, between customer 1010 and credit card issuer 1200. Telephone response vehicle 1120 may handle telephonic communications between the customer 1020 and credit card issuer 1200. Thus, in the event credit card issuer 1200 wishes to solicit customers telephonically, response vehicle 1120 includes the necessary systems to support such operations. Response vehicle 1130, on the other hand, includes the necessary systems and organizations to handle conventional mail processing to and from customer 1030. Response vehicle system 1140 includes the necessary systems and organizations to process electronic mail transactions with customer 1040. Response vehicle system 1100 may receive responses from the customers and forward them to card issuer 1200 for appropriate processing. Notifications to the customers also are performed from issuer 1200 to the customers through response vehicle 1100.

Communication channel 1400 facilitates communications between the various customer(s) and response vehicle system 1100 illustrated in FIG. 1. Such communications may include communications related to offering and issuing lines of credit for existing credit cards. Communications channel 1400 may include, for example, a telephony-based network, a local area network (LAN), a wide area network (WAN), a dedicated intranet, the Internet, and/or a wireless network. Further, any suitable combination of wired and/or wireless components and systems may be incorporated into communications channel 1400. Any suitable combination of point-to-point communications or networked communications may also be incorporated into communication channel 1400 to facilitate communication between the different entities illustrated in FIG. 1. Moreover, any part of communication channel 1400 may implemented through traditional infrastructures or channels of trade, to permit operations associated with the extra credit offers to be performed manually or in-person by the various entities illustrated in FIG. 1.

Credit card issuer 1200 receives communication information from response vehicle system 1100 and processes it using central database 1300. Database 1300 may contain various information including credit information, potential customer lists, risk scores for potential and current customers, approved customers, credit limits for approved customers, vendor tables including merchant identification numbers, customer information, purchase information, authorization information, and/or settlement information. Issuer 1200 also sends information to response vehicle system 1100 for delivery to the appropriate customers. Credit card issuer 1200 is responsible for providing various credit cards and establishing associated accounts. Credit card issuer 1200 may include one or more of the following: a bank, an acquiring bank, a merchant bank, a merchant or any commercial institution capable of providing a credit card consistent with the features disclosed herein. Further, although FIG. 1 only illustrates one credit card issuer 1200, it is of course possible that more than one credit card issuer be provided in system environment 1000.

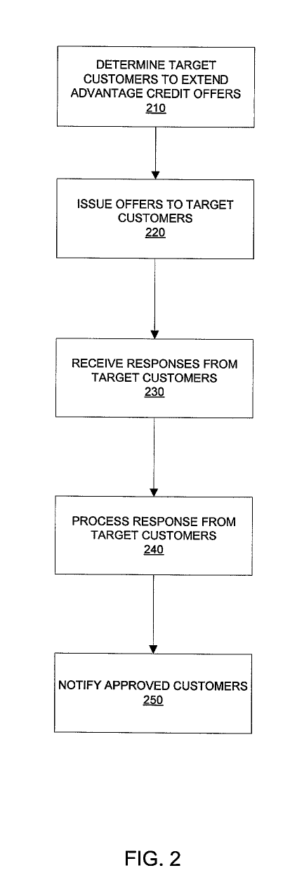

FIG. 2 illustrates an exemplary process associated with soliciting offers and processing responses for advantage credit lines from credit card customers. According to an aspect of the invention, to issue lines of credit to potential customers, credit card issuer 1200 may identify specific target customers to receive an advantage credit line offer (Step 210). To evaluate and identify target customers, several factors may be considered by the card issuer 1200. Such factors may be based on credit information received from one or more credit information sources (i.e., sources that provide credit information to credit card issuer 1200). Credit information may also be provided to credit card issuer 1200 when customers respond to credit card offers from issuer 1200. Moreover, credit information may be requested by issuer 1200 when determining a target customer group to extend offers. Credit information may include credit history information and/or personal information (e.g., income, employment status, etc.) that is used when evaluating a customer's credit rating or worthiness. Credit information sources may comprise a commercial credit information source (such as TRW/Experian, Equifax and TransUnion or a similar commercial credit service bureau) and/or private credit information services.

The credit information is analyzed to determine the credit worthiness or a level of risk associated with each target customer. If a customer's credit worthiness satisfies predetermined credit criteria, then credit card issuer 1200 may approve the customer for inclusion in a target customer group. The target customer group includes all identified customers that card issuer 1200 will provide offers for an advantage credit card product.

In accordance with certain principles related to the present invention, the advantage credit card product may be associated with a general purpose line of credit, but also associated with a specific vendor selected by the customer. Vendors may include merchants that offer goods and/or services to consumers. Such merchants may be any type of merchant offering goods and/or services. For example, a merchant may be a privately owned service/gasoline station or a franchised nationally recognized business entity, such as a supermarket chain, a electronics provider chain, etc. In general, cardholders may make purchases from merchants using advantage credit card products consistent with certain principles related to the present invention.

Once card issuer 1200 has identified a target group of customers (which may then be stored in central database 1300) it generates offers for these selected customers. The offers may vary for each customer based on the credit worthiness determined in Step 210 (see FIG. 2). That is, a customer with a high credit risk may be offered a product having a credit line with a relatively low available balance (e.g., $500). Another customer with a lower credit risk may be offered a line of credit with a relatively high available balance (e.g., $5000). The options available to the card issuer 1200 may extend beyond these options as well, and one skilled in the art would realize that the present invention is not limited to the above examples.

Once the offers are generated, they are sent to response vehicle system 1100 for distribution to the customers (Step 220). Each response vehicle in vehicle 1100 processes the offers in order to provide them to the customers through the proper medium or communication channel. For instance, response vehicle 1110 formulates offers for generation and viewing on one or more web sites. These web sites may be associated with sites that are operated by selected vendors. Once each response vehicle has processed the offers, they are sent to the specified customers for response. Customers 1010-1040 may respond (accept or decline) to the offers using the medium associated with their category. The responses are sent back to response vehicle system 1100 (Step 230), where they are processed for presentation to card issuer 1200 (Step 240).

Based on the category of a customer, responses may or may not be processed immediately. For instance, responses may be received and processed instantaneously for customers 1010 and 1020, while responses from customers 1030 may be delayed. For example, suppose a customer 1010 using a personal computer, views a web site operated by issuer 1200. The site may include a designated page that is presented to the customer that displays the offer determined by issuer 1200. The customer may decide to accept or decline the offer by merely selecting an icon representing their choice, and perhaps providing credit information through the web site. The response is then sent back to response vehicle 1110. Response vehicle 1110 processes the response and prepares it for presentation to card issuer 1200. The response is processed at card issuer 1200 and a notification may be sent back to customer 1010, through response vehicle 1110 (Step 250). The notification may indicate to the customer that their response to an offer has been processed and whether or not an advantage credit card was approved. The notifications may be displayed through a Web page that the customer was viewing when the offer was presented or on a separate Web page. In one configuration consistent with the present invention, the customer may check the Web page to receive the notification. Alternatively, credit card issuer 1200 may provide an e-mail to the customer including the notification or a message indicating to the customer to check a particular Web site to receive the notification.

As can be seen, a customer who has accepted an offer through a web site may receive immediate notification of an approval for an advantage credit card provided by credit card provider 1200. On the other hand, a customer who has been solicited by conventional mail, such as customer 1030, may respond to the offer by mailing back an acceptance and application form to the card issuer. The response form may be received and processed by response vehicle 1130, and eventually processed by credit card issuer 1200. Notification of an acceptance by credit card issuer 1200 may then be sent back to the customer using the same conventional mail process.

There may be a plurality of variations available to card issuer 1200 when communicating with customers. That is, a mail customer 1030 may wish to respond by telephone or through a web site. Additionally, customers may respond by one medium, and request notification by another. For instance, a customer 1030 who has received an offer in the mail, may respond by mail, yet request notification by email. Accordingly, a variety of user friendly options are available to customers for receiving and responding to the offers presented by card issuer 1200. The above descriptions are for illustrative purposes alone and should not be viewed as limitations to the present invention. One of ordinary skill in the art would realize that any number of combinations of communication techniques may be implemented without departing from the principles of the present invention.

In one configuration consistent with certain principles related to the present invention, along with offers for an advantage credit card, target customers may also be provided with a request for selecting a vendor to be associated with the advantage credit card if approved by credit card issuer 1200. The request may be accompanied with information that indicates incentives for using the advantage credit card at the selected vendor's site. These incentives may be associated with one or more advantage credit parameters including advantage credit terms, such as an interest rate that may be lower than an interest rate included with a standard credit parameter associated with the advantage credit card. Credit card issuer 1200 may apply the advantage interest rate to purchase transactions associated with the vendor selected by the customer and apply the standard credit interest rate to purchase transactions associated with other vendors. Alternatively, the one or more advantage credit parameter may include terms that allow credit card issuer 1200 to remove or reduce certain fees associated with the advantage credit card based on purchase transactions from the selected vendor using the advantage credit card. For example, the one or more advantage credit parameters may include a term that indicates to credit card issuer 1200 that an annual fee associated with the advantage card is to be removed when the customer makes a predetermined number of transactions with the selected vendor using the advantage credit card. One skilled in the art would realize that a variety of different parameters and/or combinations of parameters, may be provided by credit card issuer 1200 to provide incentives to the customer for accepting and using the advantage credit card with purchases associated with the selected vendor.

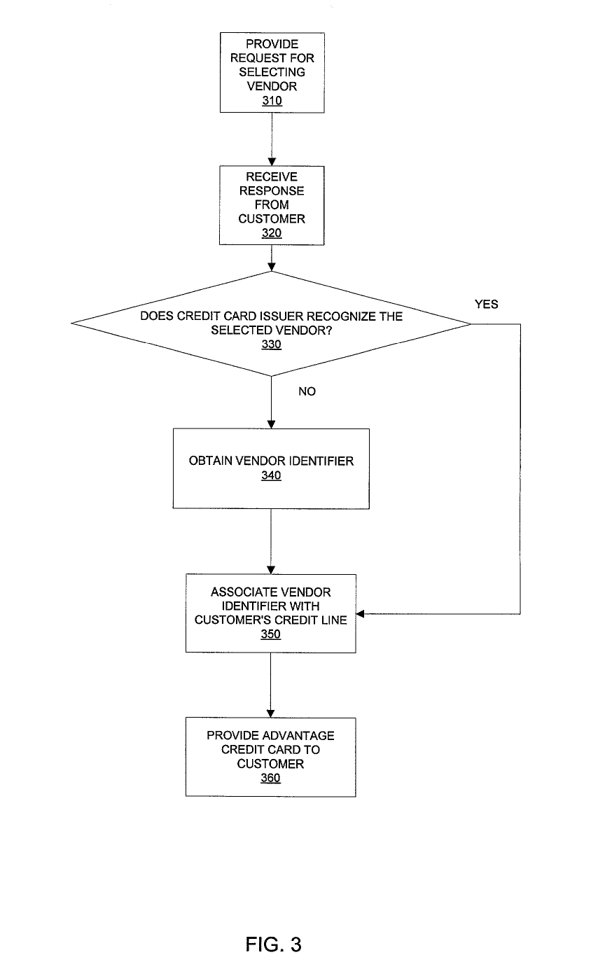

FIG. 3 illustrates an exemplary process that may be performed by credit card issuer 1200 when processing a target customer's selection of a vendor for an advantage credit card. A customer may receive a request for selecting a vendor in the offer for an advantage credit card provided by credit card issuer 1200. Alternatively, credit card issuer 1200 may provide the request for a vendor selection after the customer has accepted an offer for an advantage credit card (and was subsequently approved by credit card issuer 1200). In any event, credit card issuer 1220 provides a request for selecting a vendor to be associated with their advantage credit card (Step 310). In one configuration consistent with certain principles related to the present invention, the customer may be provided with a listing of vendors that credit card issuer 1200 has associated vendor identifiers. Vendor identifiers may be codes that are used to correlate a particular vendor with a purchase transaction made by a customer of credit card issuer 1200. The customer may select a vendor included in the list, or alternatively, may choose a vendor not included in the list. Once the customer selects a vendor, the selection may be included in a response which may be transferred to credit card issuer 1200 through response vehicle 1100 (Step 320).

Credit card issuer 1200 may then determine whether it recognizes the vendor selected by the customer. In one configuration consistent with the present invention, credit card issuer 1200 may determine whether it recognizes a vendor identifier associated with the selected vendor (Step 330). This may be performed a variety of ways. For example, the customer may have been prompted in the request to provide the vendor identifier for the vendor selected from the list of vendors included in the request. Alternatively, central database 1300 may include a listing of vendors and their associated vendor identifiers. This listing may be updated each time credit card issuer 1200 processes a purchase transaction with a vendor that is not included in the listing stored in central database 1300. Credit card issuer 1200 may perform a search of central database 1300 to determine the vendor identifier for the selected vendor indicated in the customer's response.

If credit card issuer 1200 does recognize the selected vendor (Step 330; YES), the process continues at Step 350, described below. On the other hand, if credit card issuer 1200 does not recognize the selected vendor (Step 330; NO), the identifier for the selected vendor is obtained (Step 340). Credit card issuer 1200 may obtain the vendor identification using a number of different techniques. One technique may be to request that the customer provide the vendor identification for the selected vendor. For example, if a customer wishes to associate their advantage credit card with a privately owned neighborhood gas station, the customer may have the burden of obtaining a vendor identification number (used for credit card transactions) from the gas station. Alternatively, credit card issuer 1200 may obtain the vendor identification from various sources. For instance, credit card issuer 1200 may contact the selected vendor site themselves to obtain the identification number, or obtain the vendor identification from a third party entity (such as a credit information service) based on information provided by the customer (such as the vendor's address or name). One skilled in the art would realize that the manner by which credit card issuer 1200 obtains the vendor identification for a selected vendor is not limited to the above examples, and other techniques may be implemented without departing from the spirit and scope of the present invention.

Once the vendor identifier for the selected vendor is obtained, the selected vendor is associated with a newly created advantage credit line for the customer (Step 350). The new advantage credit line may be added to the credit information maintained in central database 1300. The new advantage credit line may be formatted in central database 1300 as the other credit lines associated with the other customers of credit card issuer 1200. For example, central database 1300 may include tables, listings, mappings, arrays, and the like, that provide customer information, information associated with the customer's current credit line(s), including standard and advantage credit lines, and standard and advantage credit parameters associated with those credit lines.

In one configuration consistent with certain principles related to the present invention, the customer's advantage credit line may include a standard credit parameter including a single credit limit that is adjusted based on purchase transactions made with the advantage credit card, including those transactions made with the selected vendor. Also, the standard credit parameter information may include a standard credit term, such as an interest rate that may be applied by credit card issuer 1200 to purchase transactions made with vendors other than the vendor selected by the customer. Additionally, the advantage credit line may also be associated with an advantage credit parameter including an advantage credit term, such as advantage interest rate that may be applied by credit card issuer 1200 to purchase transactions made with the vendor selected by the customer. Alternatively (or in addition to the advantage interest rate term), the advantage credit line may include an advantage credit parameter including a term that indicates to credit card issuer 1200 to waive selected finance fees associated with the advantage credit line. For example, this term may be associated with a flag, or indicator, that credit card issuer 1200 may recognize and allow it to remove an annual membership fee from the advantage credit card account. Credit card issuer 1200 may set this flag or indicator based on a condition associated with the advantage credit line and the selected vendor, such as a predetermined number of purchase transactions associated with the selected vendor. Alternatively, credit card issuer 1200 may include with the advantage credit parameter a value that reflects the predetermined number of purchase transactions required for a particular finance fee to be waived. Further, the standard and advantage credit parameter information may reflect any account term that is more favorable to the customer for purchases with the selected vendor. One skilled in the art would realize that the format and type of information maintained in central database 1300 may vary without affecting the spirit and scope of the present invention.

In one configuration consistent with the present invention, the advantage credit parameters may include terms that allow the customer to obtain additional incentives offered by the selected vendor beyond those incentives typically given to non-advantage credit card product customers. For example, the additional incentives may be additional bonus miles associated with a frequent flyer account the customer and a selected airline vendor. That is, the customer may receive 2 bonus miles for every dollar included in a purchase transaction with the selected airline vendor while non-advantage credit card customers may receive only 1 bonus mile for every dollar included in a purchase transaction with the same airline vendor. One skilled in the art would realize that the example described above is exemplary and a number of different types of incentives may be associated with the advantage credit parameters without departing from the scope of the present invention.

Once the advantage credit line is added to central database 1300, credit card issuer 1200 may generate an advantage credit card product and provide it to the customer via response vehicle 1100 (Step 360). Also, the customer may be provided with information associated with their new advantage credit line account, such as available balance, terms, conditions, and benefits.

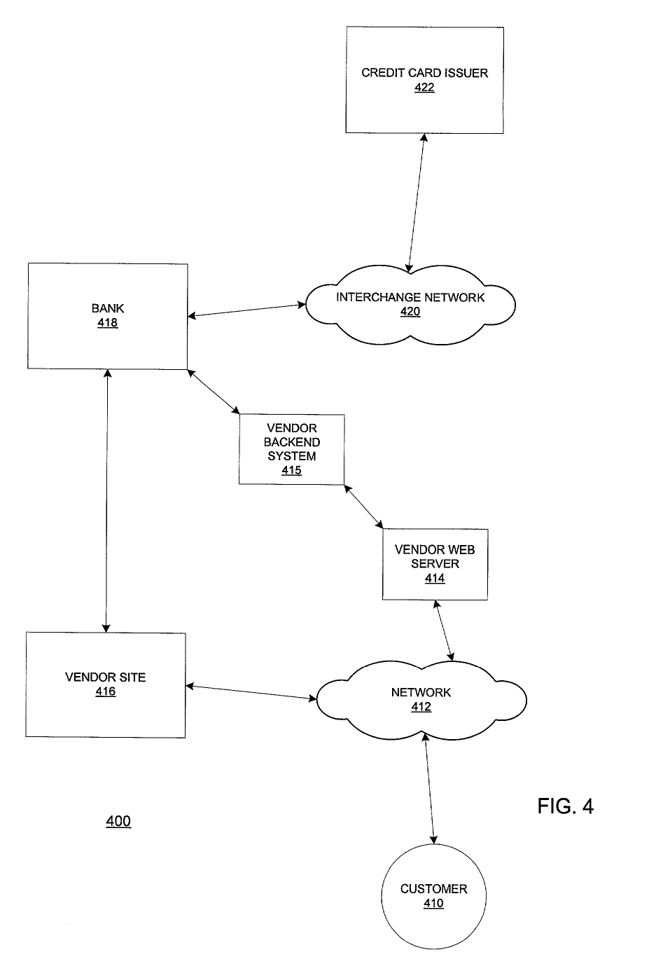

FIG. 4 illustrates another exemplary environment 400 in which features and principles of the present invention may be implemented. FIG. 4 may be implemented with a plurality of vendor sites and web servers, as well as a number of credit card issuers and associated web servers. Environment 400 includes customer 410, network 412, vendor web server 414, vendor backend system 415, vendor “brick and mortar” site 416, acquiring bank 418, interchange network 420, and credit card issuer 422.

Network 412 may represent any known communication network that allows the exchange of information electronically. For example, network 412 may represent the Internet or a combination of local area networks or public networks connecting to the Internet.

Customer 410 may be a customer who has an advantage credit card account with credit card issuer 422 in accordance with certain principles related to the present invention. Customer 410 may connect to network 412 using a personal computer (PC) or other device (e.g., wireless phone, PDS, thin client, etc.) to access web sites operated by web server 414. Customer 410 may also be a customer who is physically at vendor site 416 performing purchase transactions.

Vendor site 416 may be a merchant's location, such as an outlet store, where customers purchase goods and/or services directly from the merchant. Vendor site 416 may process a large number of purchase transactions from a variety of customers, including customer 410. For exemplary purposes, vendor site 416 may be affiliated with a vendor that customer 410 selects to be associated with the customer's advantage credit card. Vendor web server 414 may operate a retail web site where customers may purchase goods and/or services offered by the vendor on-line through network 412. Vendor backend system 415 processes purchase transactions received at the vendor's web site from vendor web server 414, and forwards transaction information to acquiring bank 418.

Acquiring bank 418 may represent an institution that processes all financial transactions for vendor site 416 and web server 414. Acquiring bank 418 may receive a large number of transactions from a plurality of different vendor sites for a diverse group of customers. The customers may purchase goods and/or services using credit cards issued from different credit card issuers, including credit card issuer 422. Acquiring bank forwards these credit card transactions to interchange network 420 for processing.

Interchange network 420 may be a commercially available interchange network, such as a VISA or MASTERCARD network. Interchange network 420 processes transaction information received from acquiring bank 418. Network 420 filters the transactions based on the type of credit cards used by customers initiating the transactions at vendor site 416 and/or vender web server 414. Interchange network 420 forwards the filtered transaction information to the appropriate credit card issuer, including credit card issuer 422.

Credit card issuer 422 may issue credit cards, including advantage credit cards, to customers and maintain each customer's account. Card issuer 422 may also receive and authorize transaction information from interchange network 420. Further, credit card issuer 422 may generate and provide offers for advantage credit lines to specified customers, as described above with respect to FIGS. 2 and 3.

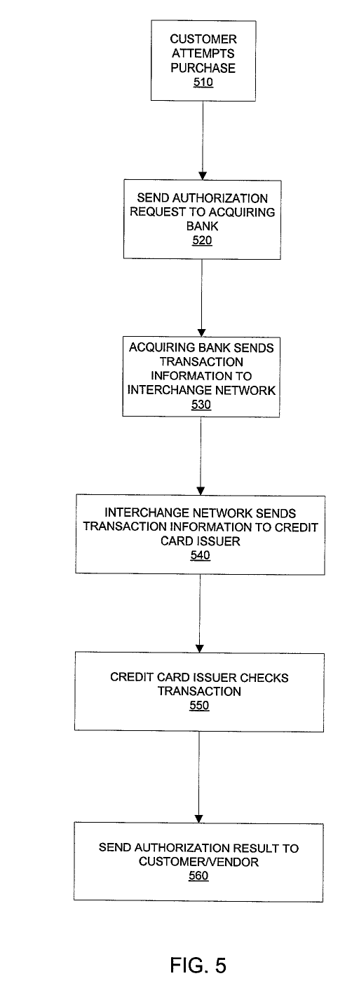

FIG. 5 illustrates an exemplary process associated with authorizing an advantage credit card purchase made by customer 410 in environment 400. As shown, a customer may attempt a purchase transaction at either vendor site 416 or a web site operated by web server 414 (Step 510). For example, if customer 410 attempts a purchase at vendor site 416, the customer may present their advantage credit card at a point of sale (POS) terminal to complete the purchase. Personnel at site 416 may process the advantage credit card by “swiping” the credit card through a credit card processing instrument at the POS terminal. The POS terminal may then generate transaction information specific to the attempted purchase, including the customer's credit card information. The POS terminal sends the transaction information to acquiring bank 418 through an electronic link (Step 520). Alternatively, if a transaction is attempted at a vendor web site operated by vendor web server 414, the customer may provide their credit card information to web server 414 using a web browser or another application. Web server 414 may forward the customer's credit card information, along with the purchase data, to backend system 415 for processing. The transaction information, including the customer's credit card data, is then packaged and may be sent to acquiring bank 418.

Acquiring bank 418 processes the transaction information and forwards it to interchange network 420 (Step 530). The processing performed by acquiring bank 418 may include transaction processing known in the art, such as sorting purchase transactions, recording the transactions, etc. Once received, interchange network 420 may filter the transaction information from other transactions received from other vendor sites. The purchase transaction from customer 410 may be filtered and aggregated with other transactions involving credit cards issued from card issuer 422. Interchange network 420 may then send the filtered transaction information to issuer 422 for authorization (Step 540).

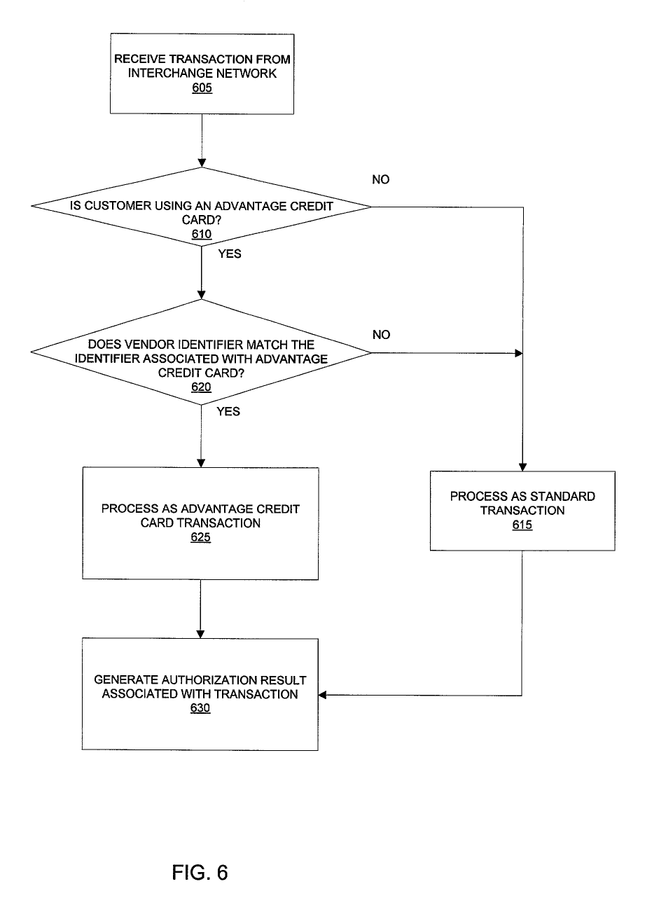

Credit card issuer 422 may receive the transaction information and determine whether the purchase should be authorized (Step 550). Details regarding the authorization process is described with reference to the description of FIG. 6. Card issuer 422 may then send the results of the authorization process back to interchange network 420 for distribution to vendor site 414 (Step 560). Vendor site 414 may either complete or deny the transaction based on the results of the authorization process.

FIG. 6 illustrates an exemplary process associated with card issuer 422 checking the validity of the purchase transaction of customer 410, in accordance with certain principles related to the present invention. As shown in FIG. 6, card issuer 422 may receive transaction information associated with customer 410 from interchange network 420 (Step 605). After performing well known security checks regarding the customer's account, (i.e., verifying the customer's account number, etc.), card issuer 422 may determine whether customer 410 is using an advantage line of credit (Step 610). In particular, issuer 422 may access the data of central database 1300 to determine whether the account identified in the received transaction information corresponds to the an advantage credit account. If not (step 610; NO), the transaction is processed as a standard transaction (Step 615). That is, credit card issuer 422 may determine whether attempted purchase amount would exceed the available balance associated with the customer's standard line of credit. Accordingly, if the customer's available balance is sufficient for the attempted purchase, credit card issuer 422 may authorize the purchase, process the transaction for billing purposes (i.e., subtract the purchase amount from the available balance, assess processing fees, etc.), and generate an authorization result associated with the purchase transaction (indicating a valid transaction, sufficient funds, etc.) (Step 630). Alternatively, if the attempted purchase amount exceeds the available balance, the authorization result may indicate the denial of the transaction.

Referring back to Step 610, in the event the customer is using an advantage credit card (Step 610; YES), credit card issuer 422 may access database 1300 to determine whether a vendor identifier associated with vendor site 416 and/or vendor web server 414 matches the identifier correlating to the vendor selected by customer 410 and affiliated with the advantage credit card (Step 620). If not (Step 620; NO), the transaction is processed as a standard transaction (Step 615). If, however, the vendor identifier associated with vendor site 416 does match the vendor identifier associated with customer 410's advantage credit card (Step 620; YES), the attempted purchase transaction is processed as an advantage credit card transaction (Step 625).

In one configuration consistent with certain principles related to the present invention, an advantage credit card transaction may be processed by performing the same transaction processing that is performed in a standard transaction process (i.e., Step 615). That is, if the transaction is authorized, the attempted purchase amount may be subtracted from the available balance associated with the advantage credit card. In addition to the standard processing, however, credit card issuer 422 may generate an indication that reflects that this transaction is an authorized advantage credit card transaction and should be processed using the advantage credit account parameters. The indication may be setting a flag in a file, associated with customer 410, located in central database 1300. In one configuration consistent with certain principles related to the present invention, the flag may be associated with a transaction number that may be generated that uniquely identifies the attempted purchase transaction at vendor site 416. Alternatively, the transaction number itself may be modified to reflect the affiliation of it with an authorized advantage credit card transaction. One skilled in the art would realize that credit card issuer 422 may implement a variety of different techniques that enable it to recognize that the purchase transaction at vendor site 416 by customer 410 is an authorized advantage credit card transaction, without departing from the spirit and scope of the present invention.

Once the advantage credit card transaction processing is completed (Step 625), credit card issuer 422 may generate an authorization result associated with the purchase transaction for provision to vendor site 416 (Step 630). One skilled in the art would realize that if the attempted purchase took place through web server 414, that the authorization result may be provided to vendor backend system 415 for provision to web server 414.

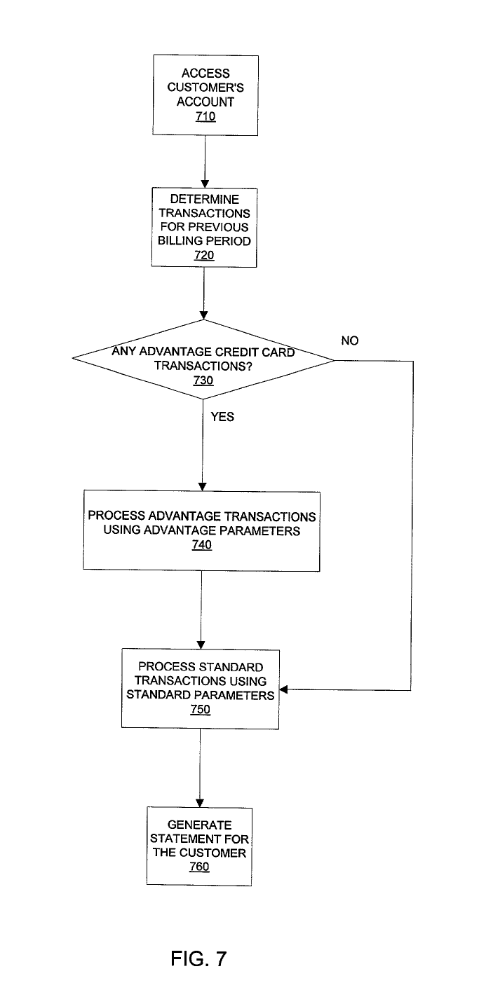

As described, methods, systems, and articles of manufacture consistent with certain principles related to the present invention may allow a customer, such as customer 410, to use their advantage credit card as a standard credit card to purchase goods and/or services from any vendor that accepts credit card purchases. As described above, the advantage credit card may further allow a customer to select a particular vendor through which purchase transactions are processed according to predetermined “advantage credit parameters.” As also described above, these advantage credit parameters are more favorable for the customer than the “standard credit parameters” used to process purchase transactions with other vendors. In accordance with one aspect of the present invention, the customer may not even be made aware of any processing differences between a standard credit card transaction and an advantage credit card transaction until they receive a billing statement from credit card issuer 422. FIG. 7 illustrates an exemplary process for providing a billing statement, consistent with certain principles related to the present invention. For exemplary purposes, the process shown in FIG. 7 is described with reference to credit card issuer 1200 and FIG. 1.

As shown in FIG. 7, credit card issuer 1200 may generate a billing statement for an advantage credit card customer by first accessing the customer's account stored in a memory device, such as central database 1300 (Step 710). Credit card issuer 1200 may then determine and collect all of the transactions associated with the customer for the previous billing period (Step 720). For example, if a billing period is monthly, credit card issuer 1200 may collect all of the transactions for the past month, or since the last billing statement was generated. Next, credit card issuer 1200 may determine whether there are any advantage credit card transactions included in the collected transactions (Step 730). If not (Step 730; NO), the transactions are processed using the standard parameters to determine a requirement payment for the customer (Step 750). The standard parameters may reflect a standard APR, such as 19.8%, standard monthly and/or annual fees, late payment fees, etc.

On the other hand, if there are advantage credit card transactions (Step 730; YES), these transactions are processed using the advantage parameters (Step 740). In one configuration consistent with certain principles related to the present invention, the advantage parameters may include an APR that is lower than the standard APR, such as 9.8%. Alternatively, the advantage parameter may be an indication of a number of transactions associated with the advantage credit card and the selected vendor over a predetermined period of time, such as 1 year or 6 months. In this configuration, certain fees, such as maintenance, membership, and penalty fees, may be eliminated or reduced when the advantage credit card product was used to make a certain number of purchases with the selected vendor over the predetermined period of time. Thus, the advantage credit card transactions may be processed using the advantage parameters to allow the customer to receive the incentives associated with the advantage credit card for purchasing goods and/or services form their selected vendor. Once all of the advantage credit card transactions are processed, the remaining standard transactions may be processed (Step 750) and credit card issuer 1200 may generate a billing statement for the customer (Step 760). The billing statement may include indications of payments that are due by the customer based on the purchases made in the previous billing period. The billing statement may also indicate the amount of funds saved (or reduced) by using the advantage credit card with the selected vendor. One skilled in the art would realize that the billing statement may be formatted in a variety of ways, and may include information associated with a variety of credit card information, such as standard parameters, minimum monthly payment due, available balance, assessed fees, removed fees (perhaps based on any advantage credit card transactions), advantage credit card parameters, such as the advantage APR, etc.

As described, methods, systems, and articles of manufacture consistent with certain principles related to the present invention enable credit card holders to obtain advantage credit cards that provide incentives for transactions associated with a selected vendor. Because there are no restrictions on particular vendors a customer may select to be affiliated with their advantage credit card, the customer is free to select nationally or locally recognized vendors. Therefore, the incentives offered with the advantage credit card may be realized by the customer each time a purchase is made from the selected vendor.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims. For example, the process steps shown in FIGS. 2, 3, and 5-7 are not limited to the sequences described above. Variations of these sequences, such as the removal and/or the addition of other processes may be implemented without departing from the spirit and scope of the present invention. Also, the structure and configurations of the environments shown in FIGS. 1 and 4 are also not intended to be limiting and one skilled in the art would realize that various other components, architectures, and configurations may be implemented without departing form the scope of the present invention.

Furthermore, although aspects of the present invention are described as being associated with data stored in memory and other storage mediums, one skilled in the art will appreciate that these aspects can also be stored on or read from other types of computer-readable media, such as secondary storage devices, like hard disks, floppy disks, or CD-ROM; a carrier wave from the Internet; or other forms of RAM or ROM. Accordingly, the invention is not limited to the above described embodiments, but instead is defined by the appended claims in light of their full scope of equivalents

What is claimed is:

1. A method for managing a financial account, comprising:
providing a consumer with the financial account having a first account component and a second account component, wherein the first and second account components have respective first and second account parameters associated with purchase transactions made by the consumer using the financial account;
allowing the consumer to select a vendor to be associated with the first account component; and
processing purchase transactions with the selected vendor based on the first account parameter; and processing purchase transactions with other vendors based on the second account parameter.

2. The method of claim 1, further comprising:
generating a billing statement reflecting an amount to be paid by the consumer based on the first and second account parameters, wherein the amount to be paid is reduced when based on the first account parameter.

3. The method of claim 1, wherein the financial account is a credit card account and the consumer may select any vendor that accepts purchases using the credit card account.

4. The method of claim 1, wherein the first account parameter is a first interest rate and the second account parameter is a second interest rate different from the first interest rate.

5. The method of claim 1 wherein the purchase transactions are associated with one of:
(i) an internet-based purchase transaction;
(ii) a point-of-sale purchase transaction;
(iii) a purchase transaction made over a telephone; and
(iv) a purchase transaction made using conventional mail.

6. The method of claim 1, wherein allowing the consumer to select a vendor further comprises:
presenting an offer for the financial account to the consumer, wherein the offer includes a request to select a vendor to be associated with the financial account.

7. The method of claim 6, wherein the request includes a list of vendors, and wherein the consumer may select the vendor from the list.

8. The method of claim 6, wherein the request includes a list of vendors, and wherein the selected vendor is not included in the list.

9. The method of claim 1, wherein the financial account includes an available balance that is adjusted based on the purchase transactions with the selected and other vendors.

10. The method of claim 1, wherein processing purchase transactions with the selected vendor comprises:
applying first fees to the financial account for purchase transactions with the selected vendor based on the first account parameter.

11. The method of claim 10, wherein processing purchase transactions with the other vendors comprises:
applying second fees to the financial account for purchase transactions with the other vendors based on the second account parameter, wherein the second fees are higher than the first fees.

12. The method of claim 11, wherein the first and second account parameters are first and second interest rates, respectively, wherein the first interest rate is lower than the second interest rate.

13. The method of claim 11, wherein the first and second account parameters include first and second finance charges, respectively.

14. The method of claim 1, wherein processing purchase transactions with the selected vendor comprises:
reducing fees charged to the financial account for purchase transactions with the selected vendor based on a number of purchase transactions with the selected vendor over a predetermined time period.

15. A system for managing a financial account, comprising:
means for providing a consumer with the financial account having a first account component and a second account component, wherein the first and second account components have respective first and second account parameters associated with purchase transactions made by the consumer using the financial account;
means for allowing the consumer to select a vendor to be associated with the first account component; and
means for processing purchase transactions with the selected vendor based on the first account parameter; and processing purchase transactions with other vendors based on the second account parameter.

16. The system of claim 15, further comprising:
means for generating a billing statement reflecting an amount to be paid by the consumer based on the first and second account parameters, wherein the amount to be paid is reduced when based on the first account parameter.

17. The system of claim 15, wherein the financial account is a credit card account and the consumer may select any vendor that accepts purchases using the credit card account.

18. The system of claim 15, wherein the first account parameter is a first interest rate and the second account parameter is a second interest rate different from the first interest rate.

19. The system of claim 15 wherein the purchase transactions are associated with one of:
(i) an internet-based purchase transaction;
(ii) a point-of-sale purchase transaction;
(iii) a purchase transaction made over a telephone; and
(iv) a purchase transaction made using conventional mail.

20. The system of claim 15, wherein the means for allowing the consumer to select a vendor further comprises:
means for presenting an offer for the financial account to the consumer, wherein the offer includes a request to select a vendor to be associated with the financial account.

21. The system of claim 20, wherein the request includes a list of vendors, and wherein the consumer may select the vendor from the list.

22. The system of claim 20, wherein the request includes a list of vendors, and wherein the selected vendor is not included in the list.

23. The system of claim 15, wherein the financial account includes an available balance that is adjusted based on the purchase transactions with the selected and other vendors.

24. The system of claim 15, wherein the means for processing purchase transactions with the selected vendor comprises:
means for applying first fees to the financial account for purchase transactions with the selected vendor based on the first account parameter.

25. The system of claim 24, wherein the means for processing purchase transactions with the other vendors comprises:
means for applying second fees to the financial account for purchase transactions with the other vendors based on the second account parameter, wherein the second fees are higher than the first fees.

26. The system of claim 25, wherein the first and second account parameters are first and second interest rates, respectively, wherein the first interest rate is lower than the second interest rate.

27. The system of claim 25, wherein the first and second account parameters include first and second finance charges, respectively.

28. The system of claim 15, wherein the means for processing purchase transactions with the selected vendor comprises:
means for reducing fees charged to the financial account for purchase transactions with the selected vendor based on a number of purchase transactions with the selected vendor over a predetermined time period.

29. A computer-readable medium including instructions for performing a method, when executed by a processor, for managing a financial account, the method comprising:
providing a consumer with the financial account having a first account component and a second account component, wherein the first and second account components have respective first and second account parameters associated with purchase transactions made by the consumer using the financial account;
allowing the consumer to select a vendor to be associated with the first account component; and
processing purchase transactions with the selected vendor based on the first account parameter; and processing purchase transactions with other vendors based on the second account parameter.

30. The computer-readable medium of claim 29, wherein the method further comprises:
generating a billing statement reflecting an amount to be paid by the consumer based on the first and second account parameters, wherein the amount to be paid is reduced when based on the first account parameter.

31. The computer-readable medium of claim 29, wherein the financial account is a credit card account and the consumer may select any vendor that accepts purchases using the credit card account.

32. The computer-readable medium of claim 29, wherein the first account parameter is a first interest rate and the second account parameter is a second interest rate different from the first interest rate.

33. The computer-readable medium of claim 29 wherein the purchase transactions are associated with one of:
(i) an internet-based purchase transaction;
(ii) a point-of-sale purchase transaction;
(iii) a purchase transaction made over a telephone; and
(iv) a purchase transaction made using conventional mail.

34. The computer-readable medium of claim 29, wherein allowing the consumer to select a vendor further comprises:
presenting an offer for the financial account to the consumer, wherein the offer includes a request to select a vendor to be associated with the financial account.

35. The computer-readable medium of claim 34, wherein the request includes a list of vendors, and wherein the consumer may select the vendor from the list.

36. The computer-readable medium of claim 34, wherein the request includes a list of vendors, and wherein the selected vendor is not included in the list.

37. The computer-readable medium of claim 29, wherein the financial account includes an available balance that is adjusted based on the purchase transactions with the selected and other vendors.

38. The computer-readable medium of claim 29, wherein processing purchase transactions with the selected vendor comprises:
applying first fees to the financial account for purchase transactions with the selected vendor based on the first account parameter.

39. The computer-readable medium of claim 38, wherein processing purchase transactions with the other vendors comprises:
applying second fees to the financial account for purchase transactions with the other vendors based on the second account parameter, wherein the second fees are higher than the first fees.

40. The method of claim 39, wherein the first and second account parameters are first and second interest rates, respectively, wherein the first interest rate is lower than the second interest rate.

41. The computer-readable medium of claim 39, wherein the first and second account parameters include first and second finance charges, respectively.

42. The computer-readable medium of claim 29, wherein processing purchase transactions with the selected vendor comprises:
reducing fees charged to the financial account for purchase transactions with the selected vendor based on a number of purchase transactions with the selected vendor over a predetermined time period.
